(19) United States
(12) Patent Application Publication
(10) Pub. No.: US 2015/0161547 A1
(43) Pub. Date: Jun. 11, 2015

(54) METHODS AND SYSTEMS TO DEFINE AND EXECUTE CUSTOMER DECLARATIVE BUSINESS RULES TO EXTEND BUSINESS APPLICATIONS

(71) Applicant: ORACLE INTERNATIONAL CORPORATION, Redwood Shores, CA (US)

(72) Inventors: AJAY AGGARWAL, SUNNYVALE, CA (US); SATYA ANUR, REDWOOD SHORES, CA (US); MARGARET WASOWICZ, HARISBURG, NC (US); WILLIAM N. CAINE, FREMONT, CA (US); TIANYI WANG, MOUNTAIN VIEW, CA (US); DINAKAR HITUVALLI, SAN JOSE, CA (US)

(73) Assignee: ORACLE INTERNATIONAL CORPORATION, REDWOOD SHORES, CA (US)

(21) Appl. No.: 14/101,652

(22) Filed: Dec. 10, 2013

(51) Int. Cl. G06Q 10/06

(52) U.S. Cl. CPC G06Q 10/06316

(57) ABSTRACT

Embodiments of the invention provide systems and methods for defining and executing custom business rules to influence or control execution of a business process and allowing software providers to deliver externally extensible business applications which in turn allow customers of those applications to implement their own business rules and conditions using a browser based UI, without modifying the actual code in the base application. A user interface (UI) based business rule configurator allows users to define business rules and conditions that can be executed by a rules engine integrated with the client extensions and no custom code is required for business users to extend the business logic and no future custom code maintenance is required.

### BACKGROUND OF THE INVENTION

Embodiments of the present invention relate generally to methods and systems for defining and executing rules and more particularly to defining and executing custom business rules to influence or control execution of a business process.

Many customers of business applications, implemented either “on-premise” or “in the cloud,” have requirements to customize the business processes executed or managed by those applications. An existing way to allow business process customization is the use of “client extensions” for the business applications. Client extensions allow addition of business rules within the standard processing flow. However, this solution requires that end users provide their own custom code. For example, to extend business application using the Transaction Control PL/SQL client extension, a customer of the business application would need to: find the appropriate client extension in the code of the application; identify business attributes such as expense type and project type; identify predefined client extension parameters; identify additional required client extension values; write the custom code to enforce the business rules; test the code; apply the code to their production database; and maintain the code in the future.

While possible, such an approach presents many issues for the customers. For example, in cloud implementations, customers do not have access to the database or development tools. So this solution cannot be used by Software as a Service (SaaS) customers. Rather, it can only be used in an on-premise scenario. Even in on-premise instances, customers need to have technically skilled resources in their IT organization to write and maintain custom code for the extended business logic. Custom implementations are also under the risk of getting overwritten by software patches that get applied at regular intervals. Additionally, there is a possible security risk of interfering with intended functionality due to uncertified code implementation by the customer's IT resources. Furthermore, there are additional customer costs involved in maintaining the code, IT resources and tools to support these custom extensions. Hence, there is a need for improved methods and systems for defining and executing custom business rules to influence or control execution of a business process.

### BRIEF SUMMARY OF THE INVENTION

Embodiments of the invention provide systems and methods for defining and executing declarative business rules to extend a business application. According to one embodiment, defining and executing custom declarative business rules to extend a business application can comprise reading a set of pre-defined rules for the business application. The rules can comprise an attribute-based set of corresponding conditions and actions executable by the business application to implement at least part of a business process. Available extensions can be identified for one or more of the pre-defined rules. The extensions can comprise at least a portion of a rule which can be edited or to which additional conditions and actions can be added. Identifying available extensions for one or more of the pre-defined rules can comprise determining whether an available extension is enabled for use in generation of a custom rule, receiving, prior to reading the set of pre-defined rules for the business application, an indication of at least one available extension being enabled, and saving the indication of the at least one available extension being enabled.

A first user interface can be generated indicating the identified available extensions and providing one or more control elements providing for selection of one of the identified available extensions. A selection of one of the identified available extensions indicated in the first user interface can be received and in response to receiving the selection of one of the identified available extensions indicated in the first user interface, a second user interface can be generated providing one or more control elements for each of one or more portions of the rule which can be edited or one or more additional conditions and actions, the one or more control elements providing for selection of values to define a customization for the extension.

Selections indicating definition of a custom rule can be received for the selected one of the identified available extensions. The custom rule can be generated based on the selected one of the identified available extensions and the received selections indicating definition of the custom rule. Generating the custom rule can comprise dynamically generating code executable by the business application to implement the at least part of the business process based on the received selections indicating definition of a custom rule. The generated custom rule can be saved and a business process can be executed by the business application using the saved customized rule.

### BRIEF DESCRIPTION OF THE DRAWINGS

FIG. 1 is a block diagram illustrating components of an exemplary distributed system in which various embodiments of the present invention may be implemented.

FIG. 2 is a block diagram illustrating components of a system environment by which services provided by embodiments of the present invention may be offered as cloud services.

FIG. 3 is a block diagram illustrating an exemplary computer system in which embodiments of the present invention may be implemented.

FIG. 4 is a block diagram illustrating, at a high-level, functional components of a system for defining and executing custom declarative business rules to extend a business application according to one embodiment of the present invention.

FIG. 5 is a flowchart illustrating a process for defining and executing custom declarative business rules to extend a business application according to one embodiment of the present invention.

FIG. 6 is a screenshot illustrating an exemplary user interface including a set of controls for enabling one or more available extensions according to one embodiment of the present invention.

FIG. 7 is a screenshot illustrating an exemplary user interface including a set of controls for defining a custom rule according to one embodiment of the present invention.

FIGS. 8A and 8B are screenshots illustrating additional details of an exemplary user interface including a set of controls for defining a custom rule according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for defining and executing custom business rules to influence or control execution of a business process. More specifically, embodiments of the present invention allow software providers to deliver externally extensible business applications which in turn allow customers of those applications to implement their own business rules and conditions using a browser based UI, without modifying the actual code in the base application. For example, to extend a business application using the Oracle Transaction Control PL/SQL client extension under embodiments of the present invention, a user of that application can identify and select the appropriate client extension using a UI drop-down list or other graphical user interface element and, through the user interface, navigate to a “Define Custom Rule” page and define rules and conditions using various other graphical or other features of that page. Various embodiments of the present invention can be implemented in either an on-premise instance of the application or in a multitenant Software as a Service (SaaS) environment, i.e., “in the cloud.” No development tools, other than a browser, are required by embodiments of the present invention to implement custom business requirements and no PL/SQL technical skills are required to implement custom rules. Rather, a simple user interface (UI) based business rule configurator allows users to define business rules and conditions that can be executed by a rules engine integrated with the client extensions. Customers of the business applications can be given the option of utilizing pre-seeded libraries of rules as a basis of custom defined rules. Under embodiments of the present invention, no custom code is required for business users to extend the business logic and no future custom code maintenance is required. Users of embodiments of the present invention can create multiple rule sets and enable or disable these as business needs change over a period of time. Various additional details of embodiments of the present invention will be described below with reference to the figures.

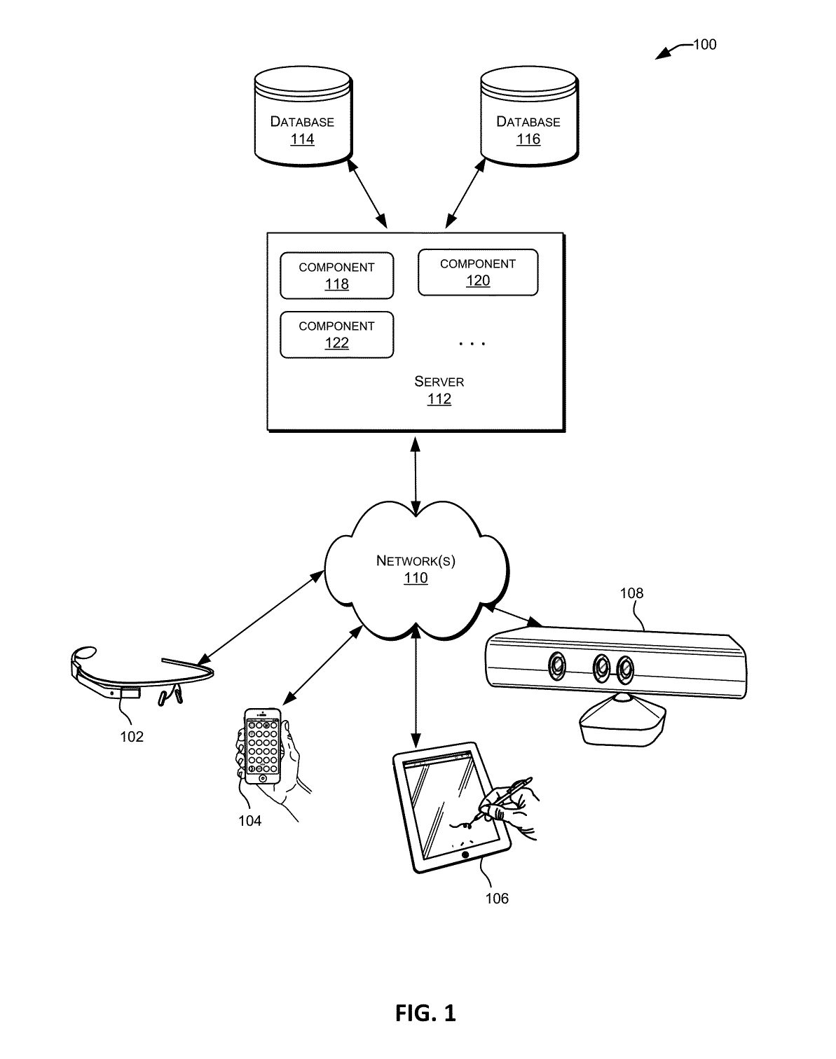

FIG. 1 is a block diagram illustrating components of an exemplary distributed system in which various embodiments of the present invention may be implemented. In the illustrated embodiment, distributed system 100 includes one or more client computing devices 102, 104, 106, and 108, which are configured to execute and operate a client application such as a web browser, proprietary client (e.g., Oracle Forms), or the like over one or more network(s) 110. Server 112 may be communicatively coupled with remote client computing devices 102, 104, 106, and 108 via network 110.

In various embodiments, server 112 may be adapted to run one or more services or software applications provided by one or more of the components of the system. In some embodiments, these services may be offered as web-based or cloud services or under a Software as a Service (SaaS) model to the users of client computing devices 102, 104, 106, and/or 108. Users operating client computing devices 102, 104, 106, and/or 108 may in turn utilize one or more client applications to interact with server 112 to utilize the services provided by these components.

In the configuration depicted in the figure, the software components 118, 120 and 122 of system 100 are shown as being implemented on server 112. In other embodiments, one or more of the components of system 100 and/or the services provided by these components may also be implemented by one or more of the client computing devices 102, 104, 106, and/or 108. Users operating the client computing devices may then utilize one or more client applications to use the services provided by these components. These components may be implemented in hardware, firmware, software, or combinations thereof. It should be appreciated that various different system configurations are possible, which may be different from distributed system 100. The embodiment shown in the figure is thus one example of a distributed system for implementing an embodiment system and is not intended to be limiting.

Client computing devices 102, 104, 106, and/or 108 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 102, 104, 106, and 108 may be any other electronic device, such as a thin-client computer, an Internet-enabled gaming system (e.g., a Microsoft Xbox gaming console with or without a Kinect® gesture input device), and/or a personal messaging device, capable of communicating over network(s) 110.

Although exemplary distributed system 100 is shown with four client computing devices, any number of client computing devices may be supported. Other devices, such as devices with sensors, etc., may interact with server 112.

Network(s) 110 in distributed system 100 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 110 can be a local area network (LAN), such as one based on Ethernet, Token-Ring and/or the like. Network(s) 110 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 112 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 112 may be adapted to run one or more services or software applications described in the foregoing disclosure. For example, server 112 may correspond to a server for performing processing described above according to an embodiment of the present disclosure.

Server 112 may run an operating system including any of those discussed above, as well as any commercially available server operating system. Server 112 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 112 may include one or more applications to analyze and consolidate data feeds and/or event updates received from users of client computing devices 102, 104, 106, and 108. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 112 may also include one or more applications to display the data feeds and/or real-time events via one or more display devices of client computing devices 102, 104, 106, and 108.

Distributed system 100 may also include one or more databases 114 and 116. Databases 114 and 116 may reside in a variety of locations. By way of example, one or more of databases 114 and 116 may reside on a non-transitory storage medium local to (and/or resident in) server 112. Alternatively, databases 114 and 116 may be remote from server 112 and in communication with server 112 via a network-based or dedicated connection. In one set of embodiments, databases 114 and 116 may reside in a storage-area network (SAN). Similarly, any necessary files for performing the functions attributed to server 112 may be stored locally on server 112 and/or remotely, as appropriate. In one set of embodiments, databases 114 and 116 may include relational databases, such as databases provided by Oracle, that are adapted to store, update, and retrieve data in response to SQL-formatted commands.

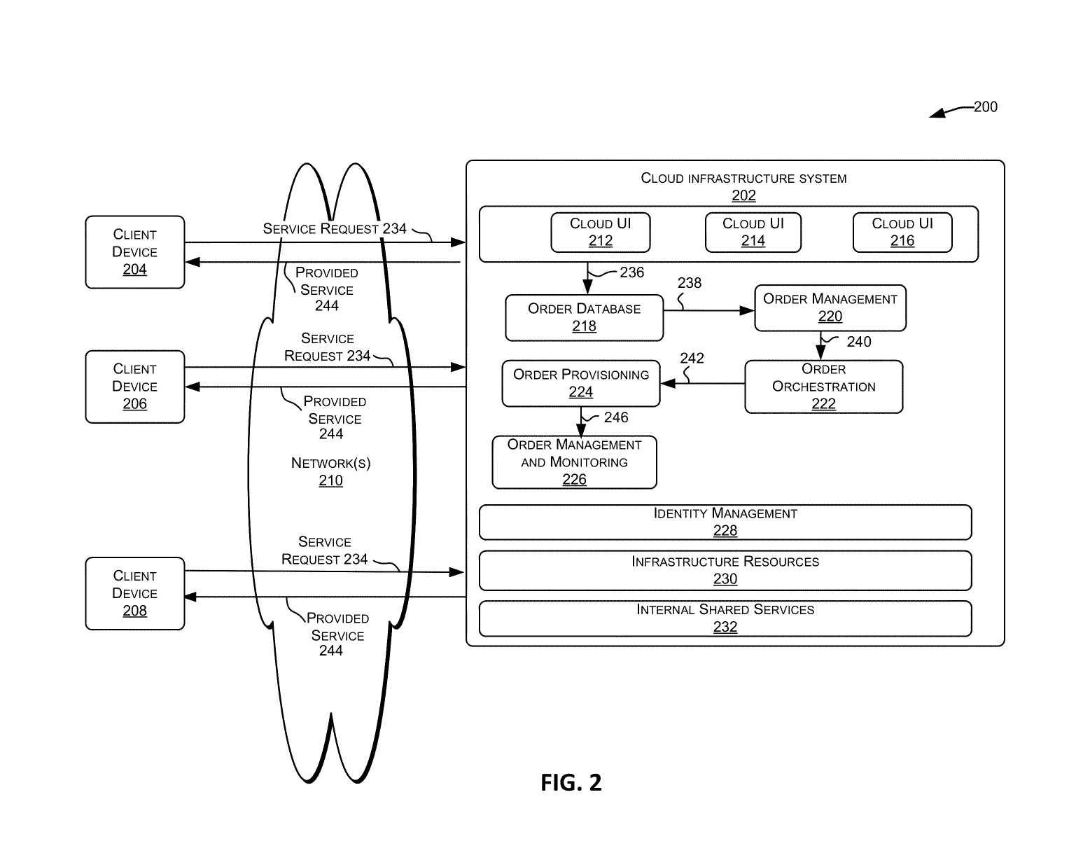

FIG. 2 is a block diagram illustrating components of a system environment by which services provided by embodiments of the present invention may be offered as cloud services. In the illustrated embodiment, system environment 200 includes one or more client computing devices 204, 206, and 208 that may be used by users to interact with a cloud infrastructure system 202 that provides cloud services. The client computing devices may be configured to operate a client application such as a web browser, a proprietary client application (e.g., Oracle Forms), or some other application, which may be used by a user of the client computing device to interact with cloud infrastructure system 202 to use services provided by cloud infrastructure system 202.

It should be appreciated that cloud infrastructure system 202 depicted in the figure may have other components than those depicted. Further, the embodiment shown in the figure is only one example of a cloud infrastructure system that may incorporate an embodiment of the invention. In some other embodiments, cloud infrastructure system 202 may have more or fewer components than shown in the figure, may combine two or more components, or may have a different configuration or arrangement of components.

Client computing devices 204, 206, and 208 may be devices similar to those described above for 102, 104, 106, and 108.

Although exemplary system environment 200 is shown with three client computing devices, any number of client computing devices may be supported. Other devices such as devices with sensors, etc. may interact with cloud infrastructure system 202.

Network(s) 210 may facilitate communications and exchange of data between clients 204, 206, and 208 and cloud infrastructure system 202. Each network may be any type of network familiar to those skilled in the art that can support data communications using any of a variety of commercially-available protocols, including those described above for network(s) 110.

Cloud infrastructure system 202 may comprise one or more computers and/or servers that may include those described above for server 112.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 202 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 202 may be adapted to automatically provision, manage and track a customer's subscription to services offered by cloud infrastructure system 202. Cloud infrastructure system 202 may provide the cloud services via different deployment models. For example, services may be provided under a public cloud model in which cloud infrastructure system 202 is owned by an organization selling cloud services (e.g., owned by Oracle) and the services are made available to the general public or different industry enterprises. As another example, services may be provided under a private cloud model in which cloud infrastructure system 202 is operated solely for a single organization and may provide services for one or more entities within the organization. The cloud services may also be provided under a community cloud model in which cloud infrastructure system 202 and the services provided by cloud infrastructure system 202 are shared by several organizations in a related community. The cloud services may also be provided under a hybrid cloud model, which is a combination of two or more different models.

In some embodiments, the services provided by cloud infrastructure system 202 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 202. Cloud infrastructure system 202 then performs processing to provide the services in the customer's subscription order.

In some embodiments, the services provided by cloud infrastructure system 202 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 202 may also include infrastructure resources 230 for providing the resources used to provide various services to customers of the cloud infrastructure system. In one embodiment, infrastructure resources 230 may include pre-integrated and optimized combinations of hardware, such as servers, storage, and networking resources to execute the services provided by the PaaS platform and the SaaS platform.

In some embodiments, resources in cloud infrastructure system 202 may be shared by multiple users and dynamically re-allocated per demand. Additionally, resources may be allocated to users in different time zones. For example, cloud infrastructure system 230 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 232 may be provided that are shared by different components or modules of cloud infrastructure system 202 and by the services provided by cloud infrastructure system 202. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 202 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 202, and the like.

In one embodiment, as depicted in the figure, cloud management functionality may be provided by one or more modules, such as an order management module 220, an order orchestration module 222, an order provisioning module 224, an order management and monitoring module 226, and an identity management module 228. These modules may include or be provided using one or more computers and/or servers, which may be general purpose computers, specialized server computers, server farms, server clusters, or any other appropriate arrangement and/or combination.

In exemplary operation 234, a customer using a client device, such as client device 204, 206 or 208, may interact with cloud infrastructure system 202 by requesting one or more services provided by cloud infrastructure system 202 and placing an order for a subscription for one or more services offered by cloud infrastructure system 202. In certain embodiments, the customer may access a cloud User Interface (UI), cloud UI 212, cloud UI 214 and/or cloud UI 216 and place a subscription order via these UIs. The order information received by cloud infrastructure system 202 in response to the customer placing an order may include information identifying the customer and one or more services offered by the cloud infrastructure system 202 that the customer intends to subscribe to.

After an order has been placed by the customer, the order information is received via the cloud UIs, 212, 214 and/or 216.

At operation 236, the order is stored in order database 218. Order database 218 can be one of several databases operated by cloud infrastructure system 218 and operated in conjunction with other system elements.

At operation 238, the order information is forwarded to an order management module 220. In some instances, order management module 220 may be configured to perform billing and accounting functions related to the order, such as verifying the order, and upon verification, booking the order.

At operation 240, information regarding the order is communicated to an order orchestration module 222. Order orchestration module 222 may utilize the order information to orchestrate the provisioning of services and resources for the order placed by the customer. In some instances, order orchestration module 222 may orchestrate the provisioning of resources to support the subscribed services using the services of order provisioning module 224.

In certain embodiments, order orchestration module 222 enables the management of business processes associated with each order and applies business logic to determine whether an order should proceed to provisioning. At operation 242, upon receiving an order for a new subscription, order orchestration module 222 sends a request to order provisioning module 224 to allocate resources and configure those resources needed to fulfill the subscription order. Order provisioning module 224 enables the allocation of resources for the services ordered by the customer. Order provisioning module 224 provides a level of abstraction between the cloud services provided by cloud infrastructure system 200 and the physical implementation layer that is used to provision the resources for providing the requested services. Order orchestration module 222 may thus be isolated from implementation details, such as whether or not services and resources are actually provisioned on the fly or pre-provisioned and only allocated/assigned upon request.

At operation 244, once the services and resources are provisioned, a notification of the provided service may be sent to customers on client devices 204, 206 and/or 208 by order provisioning module 224 of cloud infrastructure system 202.

At operation 246, the customer's subscription order may be managed and tracked by an order management and monitoring module 226. In some instances, order management and monitoring module 226 may be configured to collect usage statistics for the services in the subscription order, such as the amount of storage used, the amount data transferred, the number of users, and the amount of system up time and system down time.

In certain embodiments, cloud infrastructure system 200 may include an identity management module 228. Identity management module 228 may be configured to provide identity services, such as access management and authorization services in cloud infrastructure system 200. In some embodiments, identity management module 228 may control information about customers who wish to utilize the services provided by cloud infrastructure system 202. Such information can include information that authenticates the identities of such customers and information that describes which actions those customers are authorized to perform relative to various system resources (e.g., files, directories, applications, communication ports, memory segments, etc.) Identity management module 228 may also include the management of descriptive information about each customer and about how and by whom that descriptive information can be accessed and modified.

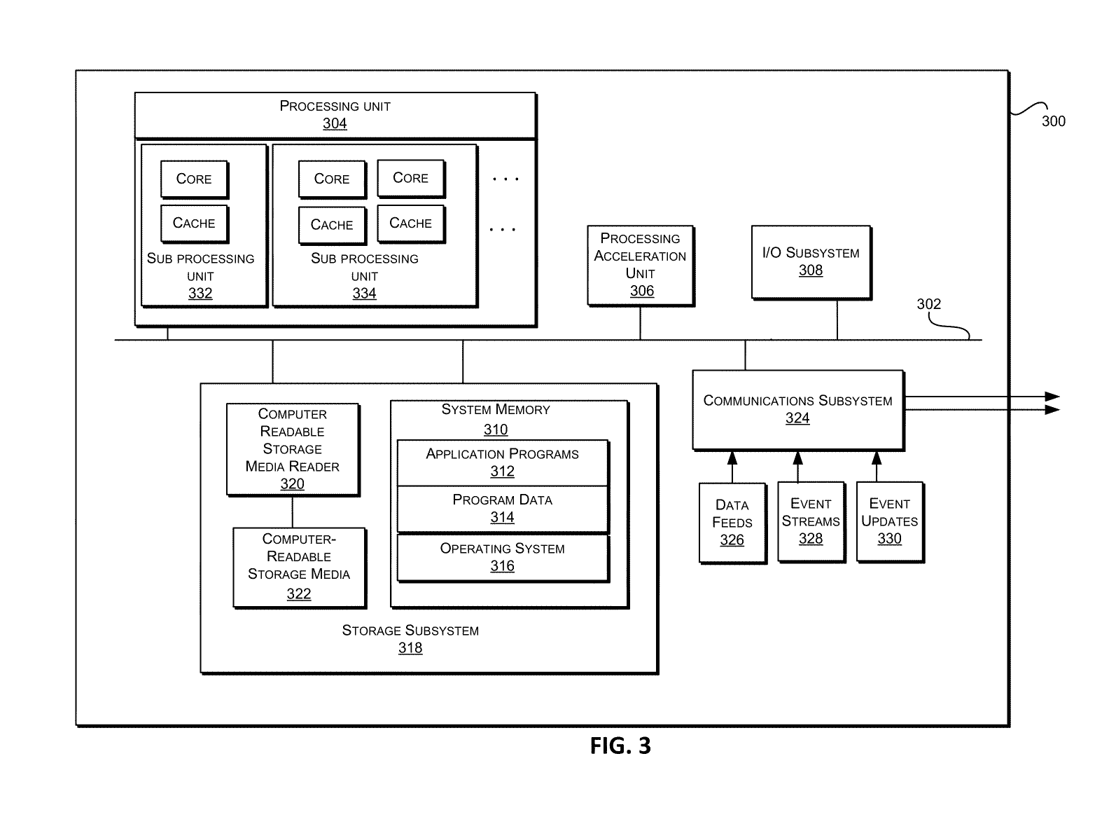

FIG. 3 is a block diagram illustrating an exemplary computer system in which embodiments of the present invention may be implemented. The system 300 may be used to implement any of the computer systems described above. As shown in the figure, computer system 300 includes a processing unit 304 that communicates with a number of peripheral subsystems via a bus subsystem 302. These peripheral subsystems may include a processing acceleration unit 306, an I/O subsystem 308, a storage subsystem 318 and a communications subsystem 324. Storage subsystem 318 includes tangible computer-readable storage media 322 and a system memory 310.

Bus subsystem 302 provides a mechanism for letting the various components and subsystems of computer system 300 communicate with each other as intended. Although bus subsystem 302 is shown schematically as a single bus, alternative embodiments of the bus subsystem may utilize multiple buses. Bus subsystem 302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 304, which can be implemented as one or more integrated circuits (e.g., a conventional microprocessor or microcontroller), controls the operation of computer system 300. One or more processors may be included in processing unit 304. These processors may include single core or multicore processors. In certain embodiments, processing unit 304 may be implemented as one or more independent processing units 332 and/or 334 with single or multicore processors included in each processing unit. In other embodiments, processing unit 304 may also be implemented as a quad-core processing unit formed by integrating two dual-core processors into a single chip.

In various embodiments, processing unit 304 can execute a variety of programs in response to program code and can maintain multiple concurrently executing programs or processes. At any given time, some or all of the program code to be executed can be resident in processor(s) 304 and/or in storage subsystem 318. Through suitable programming, processor(s) 304 can provide various functionalities described above. Computer system 300 may additionally include a processing acceleration unit 306, which can include a digital signal processor (DSP), a special-purpose processor, and/or the like.

I/O subsystem 308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 300 may comprise a storage subsystem 318 that comprises software elements, shown as being currently located within a system memory 310. System memory 310 may store program instructions that are loadable and executable on processing unit 304, as well as data generated during the execution of these programs.

Depending on the configuration and type of computer system 300, system memory 310 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 304. In some implementations, system memory 310 may include multiple different types of memory, such as static random access memory (SRAM) or dynamic random access memory (DRAM). In some implementations, a basic input/output system (BIOS), containing the basic routines that help to transfer information between elements within computer system 300, such as during start-up, may typically be stored in the ROM. By way of example, and not limitation, system memory 310 also illustrates application programs 312, which may include client applications, Web browsers, mid-tier applications, relational database management systems (RDBMS), etc., program data 314, and an operating system 316. By way of example, operating system 316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 318 may also provide a tangible computer-readable storage medium for storing the basic programming and data constructs that provide the functionality of some embodiments. Software (programs, code modules, instructions) that when executed by a processor provide the functionality described above may be stored in storage subsystem 318. These software modules or instructions may be executed by processing unit 304. Storage subsystem 318 may also provide a repository for storing data used in accordance with the present invention.

Storage subsystem 300 may also include a computer-readable storage media reader 320 that can further be connected to computer-readable storage media 322. Together and, optionally, in combination with system memory 310, computer-readable storage media 322 may comprehensively represent remote, local, fixed, and/or removable storage devices plus storage media for temporarily and/or more permanently containing, storing, transmitting, and retrieving computer-readable information.

Computer-readable storage media 322 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 300.

By way of example, computer-readable storage media 322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 322 may include, but is not limited to, Zip® drives, flash memory cards, universal serial bus (USB) flash drives, secure digital (SD) cards, DVD disks, digital video tape, and the like. Computer-readable storage media 322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 300.

Communications subsystem 324 provides an interface to other computer systems and networks. Communications subsystem 324 serves as an interface for receiving data from and transmitting data to other systems from computer system 300. For example, communications subsystem 324 may enable computer system 300 to connect to one or more devices via the Internet. In some embodiments communications subsystem 324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 324 can provide wired network connectivity (e.g., Ethernet) in addition to or instead of a wireless interface.

In some embodiments, communications subsystem 324 may also receive input communication in the form of structured and/or unstructured data feeds 326, event streams 328, event updates 330, and the like on behalf of one or more users who may use computer system 300.

By way of example, communications subsystem 324 may be configured to receive data feeds 326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 324 may also be configured to receive data in the form of continuous data streams, which may include event streams 328 of real-time events and/or event updates 330, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 324 may also be configured to output the structured and/or unstructured data feeds 326, event streams 328, event updates 330, and the like to one or more databases that may be in communication with one or more streaming data source computers coupled to computer system 300.

Computer system 300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

As noted above, embodiments of the invention provide systems and methods for defining and executing custom business rules to influence or control execution of a business process. More specifically, embodiments of the present invention allow software providers to deliver externally extensible business applications which in turn allow customers of those applications to implement their own business rules and conditions using a browser based UI, without modifying the actual code in the base application. For example, to extend a business application using Oracle Transaction Control PL/SQL client extension under embodiments of the present invention, a user of that application can identify and select the appropriate client extension using a UI drop-down list or other graphical user interface element and, through the user interface, navigate to a “Define Custom Rule” page and define rules and conditions using various other graphical or other features of that page.

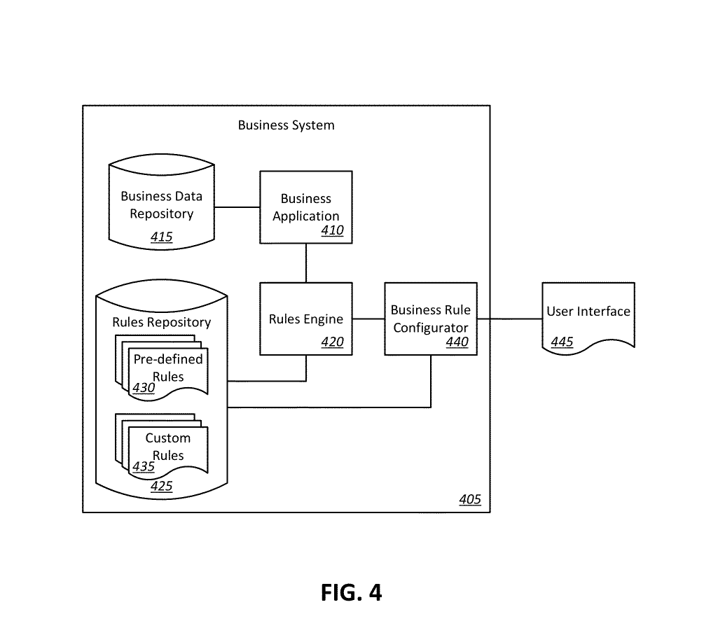

FIG. 4 is a block diagram illustrating, at a high-level, functional components of a system for defining and executing custom declarative business rules to extend a business application according to one embodiment of the present invention. As illustrated in this example, the system 400 can include a business system 405 such as any of the computer systems described above and implemented either “on-premise” or “in the cloud.” The business system 405 can execute a business application 410 such as any enterprise application including but not limited to a project management application, a procurement application, a customer relationship management application, an human capital management application, any accounting and/or financial application, etc. Such applications can maintain and utilize a set of business data stored in business data repository 415.

The business system 405 can also include a rules repository 425 including a set of pre-defined rules 430. These rules can comprise a set of instructions which can be executed by a rules engine 420 and/or the business application 410 to direct or influence a business process being executed or managed by the business application 410. It should be noted here that, while the rules repository 425 is shown as an element separate from the business data repository 415 for the sake of clarity, the business data of the business data repository 415 and the pre-defined rules 430 may be saved in a common repository or memory depending upon the exact implementation of the system 400. Additionally, while illustrated here as internal to the business system 405 either or both of these repositories 415 and 425 may be external to the business system depending upon the exact implementation. In any such implementation, the pre-defined rules 430 can also include a set of extensions or client extensions which comprise indications or definitions of interface points or “hooks” into the code or the pre-defined rule. As will be seen, these extensions can be used to provide custom definitions to extend the pre-defined rules 430 and hence extend the functionality of the business application 410 without internal modifications to the code of the business application 410.

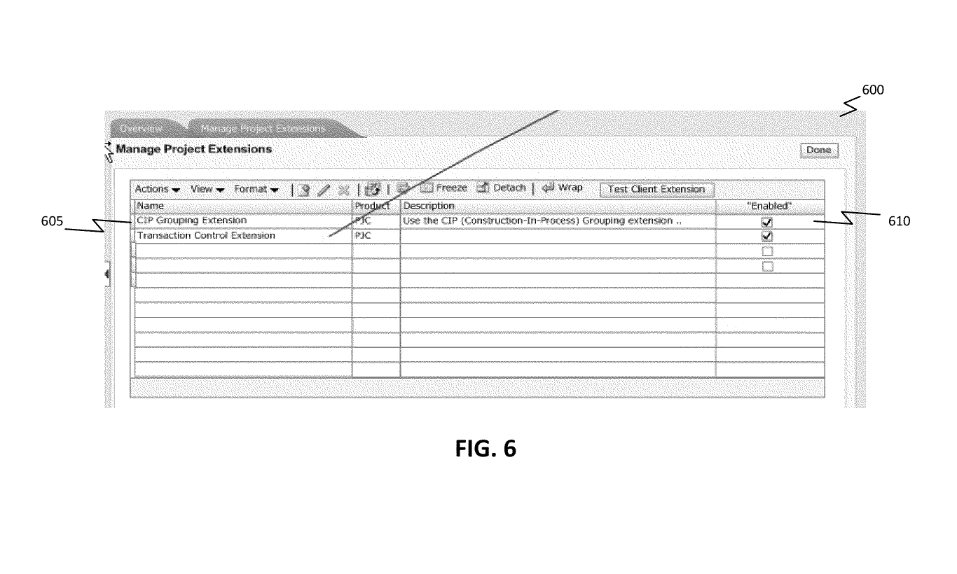

The business system 405 can additionally include a business rule configurator 440. Generally speaking, the business rule configurator 440 can provide one or more user interfaces 445 such as a set of web pages or other graphical or non-graphical interfaces through which a user can access and define rules. For instance, the business rule configurator 440 can present an interface 445 through which an administrator, manager, or other user of the system can select one or more of the pre-defined rules 430 as enabled for customization. The business rule configurator 440 can then present an interface 445 through which the administrator, manager, or other user of the system can select one of these enabled rules and provide customized definitions of the conditions and/or values of that rule to be saved as a new custom rule 435. Additionally or alternatively, the business rule configurator 440 may present an interface 445 through which a new rule, not based on a pre-defined rule 430, can be defined and saved as a custom rule 435. Examples of such interfaces 445 will be described in addition detail below with reference to FIGS. 6-8.

Generally speaking, an administrator or other user can login into the system 405 and navigate to an interface 445 of the business rule configurator 440. Based on the business requirements, this administrator can enable one or more client extensions of the pre-defined rules 430. Once a client extension is enabled, the administrator or other user can navigate to another specific interface 445 of the business rule configurator 440 based on the type of client extension and then may: define grouping criteria which will allow users to summarized the transactions based on the group defined in the interface; enable pre-configured logic for the client extension; define conditions that must satisfy in-order to execute pre-configured logic for a client extension; define rules for client extensions; etc. The rules engine 420 can process the rules and conditions defined in the interfaces 445 of the business rule configurator 440, check if a selected client extension is enabled, read a setup as defined in configuration interfaces 445 for a given client extension, apply input received for that client extension, apply inputs to the configuration rules setup, and return results as a custom rule.

Stated another way, defining and executing declarative business rules to extend a business application can comprise reading, by the business rule configurator 440, a set of pre-defined rules 430 for the business application 410. The pre-defined rules 430 can comprise an attribute-based set of corresponding conditions and actions executable by the business application 410 to implement at least part of a business process.

Once the pre-defined rules 430 have been read, available extensions for one or more of the pre-defined rules 430 can be identified by the business rule configurator 440. The extensions can comprise at least a portion of a rule which can be edited or to which additional conditions and actions can be added. In some cases, prior to reading the set of pre-defined rules for the business application, an indication of at least one available extension being enabled can be received and saved by the business rule configurator 440. That is, an administrator, manager, or other user may set, select, or otherwise indicate through a user interface 445 of the business rule configurator 440 which of a set of available extension are enabled for editing or addition. In such cases, identifying available extensions for one or more of the pre-defined rules 430 can comprise determining by the business rule configurator 440 whether an available extension is enabled for use in generation of a custom rule.

Once the available extensions have been identified by the business rule configurator 440, a first user interface 445 can be generated by the business rule configurator 440 indicating the identified available extensions and providing one or more control elements providing for selection of one of the identified available extensions. A selection of one of the identified available extensions indicated in the first user interface 445 can be received by the business rule configurator 440. In response to receiving the selection of one of the identified available extensions indicated in the first user interface 445, a second user interface 445 can be generated by the business rule configurator 440 providing one or more control elements for each of one or more portions of the rule which can be edited or one or more additional conditions and actions. The one or more control elements can provide for selection of values to define a customization for the extension.

Through the second user interface, selections indicating definition of a custom rule 435 for the selected one of the identified available extensions can be received by the business rule configurator 440 and/or rules engine 420. The custom rule 435 can be generated by the rules engine 420 based on the selected one of the identified available extensions and the received selections indicating definition of the custom rule. Generating the custom rule 435 can comprise the rules engine 420 dynamically generating code executable by the business application 410 to implement the at least part of the business process based on the received selections indicating definition of a custom rule. The generated custom rule 435 can be saved and a business process can later be executed by the business application 410 using the saved customized rule 435.

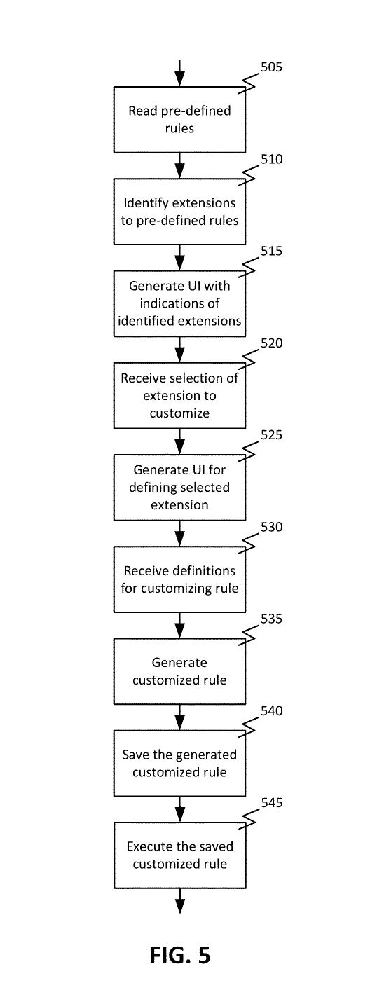

FIG. 5 is a flowchart illustrating a process for defining and executing custom declarative business rules to extend a business application according to one embodiment of the present invention. As illustrated in this example, defining and executing customer declarative business rules to extend a business application can comprise reading 505 a set of pre-defined rules for the business application. The rules can comprise an attribute-based set of corresponding conditions and actions executable by the business application to implement at least part of a business process.

Once the pre-defined rules have been read 505, available extensions for one or more of the pre-defined rules can be identified 510. The extensions can comprise at least a portion of a rule which can be edited or to which additional conditions and actions can be added. In some cases, prior to reading 505 the set of pre-defined rules for the business application, an indication of at least one available extension being enabled can be received and saved. That is, an administrator, manager, or other user may set, select, or otherwise indicate through a user interface which of a set of available extension are enabled for editing or addition. In such cases, identifying 510 available extensions for one or more of the pre-defined rules can comprise determining whether an available extension is enabled for use in generation of a custom rule.

Once the available extensions have been identified 510, a first user interface can be generated 515 indicating the identified available extensions and providing one or more control elements providing for selection of one of the identified available extensions. A selection of one of the identified available extensions indicated in the first user interface can be received 520. In response to receiving 520 the selection of one of the identified available extensions indicated in the first user interface, a second user interface can be generated 525 providing one or more control elements for each of one or more portions of the rule which can be edited or one or more additional conditions and actions. The one or more control elements can provide for selection of values to define a customization for the extension.

Through the second user interface, selections indicating definition of a custom rule for the selected one of the identified available extensions can be received 530. The custom rule can be generated 535 based on the selected one of the identified available extensions and the received selections indicating definition of the custom rule. Generating 530 the custom rule can comprise dynamically generating code executable by the business application to implement the at least part of the business process based on the received selections indicating definition of a custom rule. The generated custom rule can be saved 540 and a business process can later be executed 545 by the business application using the saved customized rule.

Other features of various embodiments can include user interfaces provided by these tools. Even though these interfaces can vary significantly in various implementations, some of the exemplary interfaces may provide particular advantages in efficiency, ease of use, etc. To better explain the functions described above, some exemplary user interfaces are provided in the figures and will be briefly described below. It should be understood that these exemplary interfaces are provided for illustrative purposes only and are not intended to limit the scope of the present invention. Rather, the actual format, content, and other features of the interfaces can vary widely between implementations without departing from the scope of the present invention.

FIG. 6 is a screenshot illustrating an exemplary user interface including a set of controls for enabling one or more available extensions according to one embodiment of the present invention. More specifically, this example illustrates a page 600 of an interface such as a web page that can include a number of controls and/or other elements 605 and 610 identifying extensions and allowing for selection of those controls to enable or disable. More specifically and as illustrated in this example, a list 605 of available extensions can be provided, in this case in a tabular form, along with a checkbox or other control 610 for each. By clicking or otherwise selecting these controls 610, the user, such as an administrator or manager, can indicate which extensions are enabled/disabled and thus available/unavailable for customization.

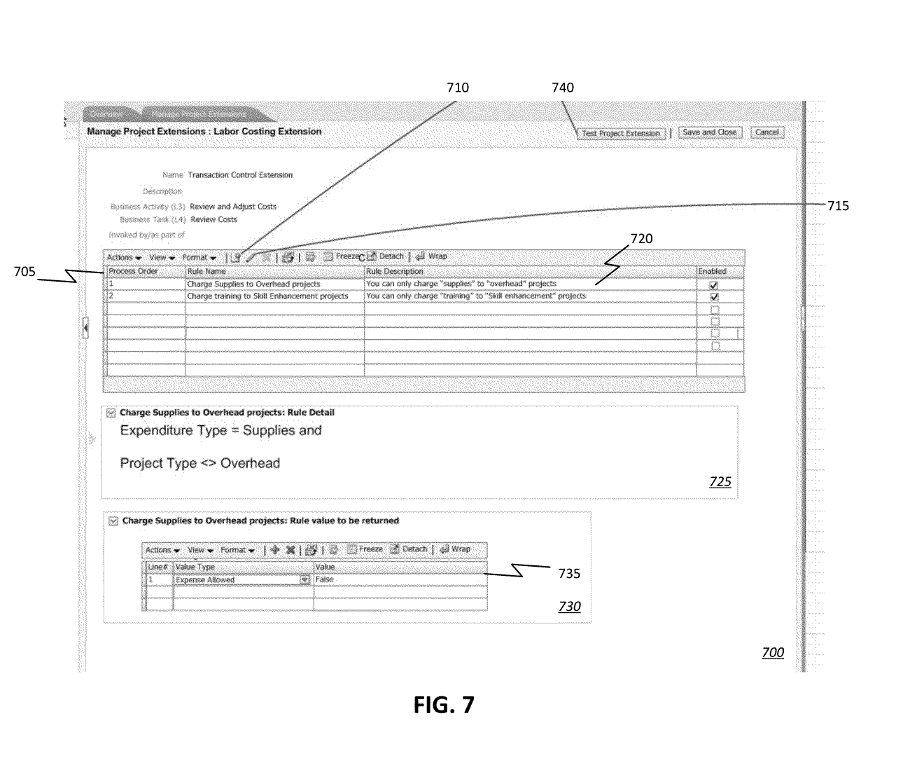

FIG. 7 is a screenshot illustrating an exemplary user interface including a set of controls for defining a custom rule according to one embodiment of the present invention. More specifically, this example illustrates a page 700 of an interface such as a web page that can include a list 705 of rules available for editing. For example, the list 705 may be presented in a tabular form and can include a description 720 of each rule. Also included can be a control 710, e.g., an icon, button, link etc., for adding a rule to the list 705 and/or a control 715 for editing a rule selected from the list 705. The page 700 can also include a portion 725 providing a detailed listing or description of a rule selected from the list 705 and a portion 730 including one or more controls 735 for values of a rule selected from the list 705.

Through such an interface page 700, users can define business rules, criteria, and return values that are very specific to their business requirements which are not met by standard functionality of pre-defined rules presented in the list 705. For example and as illustrated in FIG. 7, a user can define a business “Expense charged to a supplies must be charged to a Overhead Project” rule. Defining this rule can include defining or naming the business rule, i.e., “Charge Supplies to Overhead Projects.” The user can then define criteria for the rule i.e “Expenditure Type=‘Supplies’ and Project< >‘Overhead’” and a return value for the rule, i.e., expense is not allowed in this case when business rule definition criteria has been met.

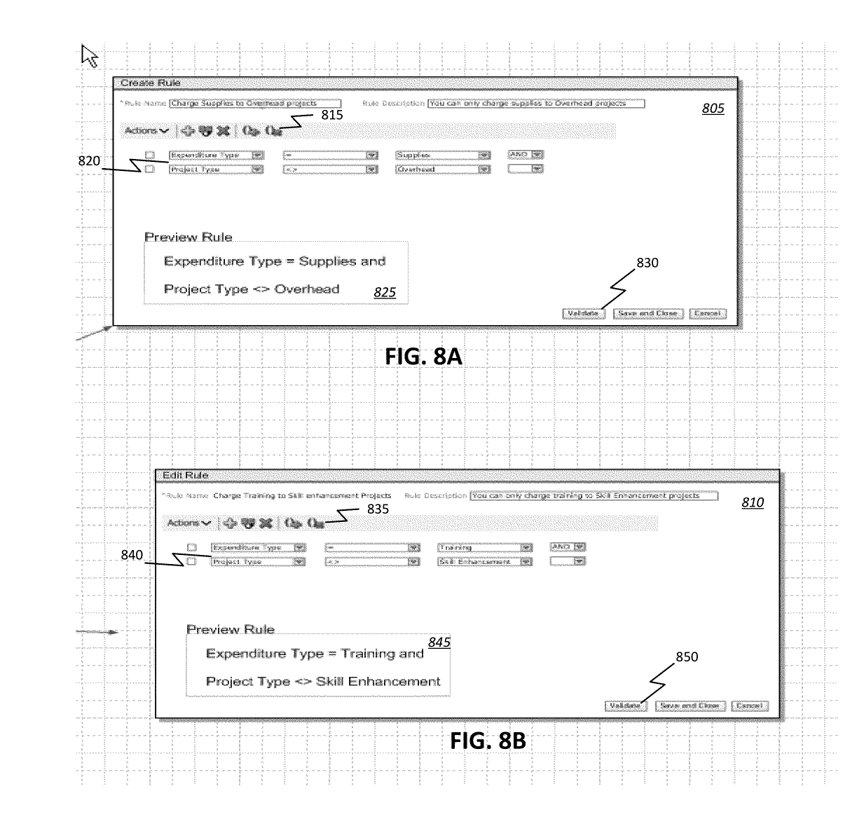

FIGS. 8A and 8B are screenshots illustrating additional details of an exemplary user interface including a set of controls for defining a custom rule according to one embodiment of the present invention. More specifically, FIG. 8A illustrates a dialog box 805 providing additional exemplary details of an interface for creating a rule. In this example, the dialog box 805 or interface can include a set of icons 815 and/or other controls 820 such as checkboxes, text boxes, combo boxes, etc. for selecting and/or defining conditions, actions, and values for the rule. The dialog box 805 can also include a portion 825 providing a detailed preview or description of a rule being created and a set of buttons 830 or other controls for controlling the creation of the rule, e.g., view, save, cancel, etc.

Similarly, FIG. 8B illustrates a dialog box 810 providing additional exemplary details of an interface for editing a selected pre-defined rule. In this example, the dialog box 810 or interface can include a set of icons 835 and/or other controls 840 such as checkboxes, text boxes, combo boxes, etc. for selecting and/or defining conditions, actions, and values for the rule. The dialog box 810 can also include a portion 845 providing a detailed preview or description of a rule being edited and a set of buttons 830 or other controls for controlling the editing of the rule, e.g., view, save, cancel, etc.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums or memory devices, such as CD-ROMs or other type of optical disks, floppy diskettes, ROMs, RAMs, EPROMs, EEPROMs, magnetic or optical cards, flash memory, or other types of machine-readable mediums or memory devices suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for defining and executing custom declarative business rules to extend a business application, the method comprising:
reading a set of pre-defined rules for the business application, the rules comprising an attribute-based set of corresponding conditions and actions executable by the business application to implement at least part of a business process;
identifying available extensions for one or more of the pre-defined rules, the extensions comprising at least a portion of a rule which can be edited or to which additional conditions and actions can be added; and
generating a first user interface indicating the identified available extensions and providing one or more control elements providing for selection of one of the identified available extensions.

2. The method of claim 1, further comprising receiving a selection of one of the identified available extensions indicated in the first user interface.

3. The method of claim 2, further comprising, in response to receiving the selection of one of the identified available extensions indicated in the first user interface, generating a second user interface providing one or more control elements for each of one or more portions of the rule which can be edited or one or more additional conditions and actions, the one or more control elements providing for selection of values to define a customization for the extension.

4. The method of claim 3, further comprising receiving selections indicating definition of a custom rule for the selected one of the identified available extensions.

5. The method of claim 4, further comprising:
generating the custom rule based on the selected one of the identified available extensions and the received selections indicating definition of the custom rule, wherein generating the custom rule comprises dynamically generating code executable by the business application to implement the at least part of the business process based on the received selections indicating definition of a custom rule; and
saving the generated custom rule.

6. The method of claim 1, wherein identifying available extensions for one or more of the pre-defined rules comprises determining whether an available extension is enabled for use in generation of a custom rule.

7. The method of claim 6, further comprising:
receiving, prior to reading the set of pre-defined rules for the business application, an indication of at least one available extension being enabled; and
saving the indication of the at least one available extension being enabled.

8. The method of claim 5, further comprising executing a business process by the business application using the saved customized rule.

9. A system comprising:
a processor; and
a memory coupled with and readable by the processor and storing therein a set of instruction which, when executed by the processor, causes the processor to define and execute custom declarative business rules to extend a business application by:
reading a set of pre-defined rules for the business application, the rules comprising an attribute-based set of corresponding conditions and actions executable by the business application to implement at least part of a business process;
identifying available extensions for one or more of the pre-defined rules, the extensions comprising at least a portion of a rule which can be edited or to which additional conditions and actions can be added; and
generating a first user interface indicating the identified available extensions and providing one or more control elements providing for selection of one of the identified available extensions.

10. The system of claim 9, further comprising:
receiving a selection of one of the identified available extensions indicated in the first user interface; and
in response to receiving the selection of one of the identified available extensions indicated in the first user interface, generating a second user interface providing one or more control elements for each of one or more portions of the rule which can be edited or one or more additional conditions and actions, the one or more control elements providing for selection of values to define a customization for the extension.

11. The system of claim 10, further comprising:
receiving selections indicating definition of a custom rule for the selected one of the identified available extensions;
generating the custom rule based on the selected one of the identified available extensions and the received selections indicating definition of the custom rule, wherein generating the custom rule comprises dynamically generating code executable by the business application to implement the at least part of the business process based on the received selections indicating definition of a custom rule; and
saving the generated custom rule.

12. The system of claim 9, wherein identifying available extensions for one or more of the pre-defined rules comprises determining whether an available extension is enabled for use in generation of a custom rule.

13. The system of claim 12, further comprising:
receiving, prior to reading the set of pre-defined rules for the business application, an indication of at least one available extension being enabled; and
saving the indication of the at least one available extension being enabled.

14. The system of claim 11, further comprising executing a business process by the business application using the saved customized rule.

15. A computer-readable memory comprising a set of instruction stored therein which, when executed by a processor, causes the processor to define and execute custom declarative business rules to extend a business application by:
reading a set of pre-defined rules for the business application, the rules comprising an attribute-based set of corresponding conditions and actions executable by the business application to implement at least part of a business process;
identifying available extensions for one or more of the pre-defined rules, the extensions comprising at least a portion of a rule which can be edited or to which additional conditions and actions can be added; and
generating a first user interface indicating the identified available extensions and providing one or more control elements providing for selection of one of the identified available extensions.

16. The computer-readable memory of claim 15, further comprising:
receiving a selection of one of the identified available extensions indicated in the first user interface; and
in response to receiving the selection of one of the identified available extensions indicated in the first user interface, generating a second user interface providing one or more control elements for each of one or more portions of the rule which can be edited or one or more additional conditions and actions, the one or more control elements providing for selection of values to define a customization for the extension.

17. The computer-readable memory of claim 16, further comprising:
receiving selections indicating definition of a custom rule for the selected one of the identified available extensions;
generating the custom rule based on the selected one of the identified available extensions and the received selections indicating definition of the custom rule, wherein generating the custom rule comprises dynamically generating code executable by the business application to implement the at least part of the business process based on the received selections indicating definition of a custom rule; and
saving the generated custom rule.

18. The computer-readable memory of claim 15, wherein identifying available extensions for one or more of the pre-defined rules comprises determining whether an available extension is enabled for use in generation of a custom rule.

19. The computer-readable memory of claim 18, further comprising:
receiving, prior to reading the set of pre-defined rules for the business application, an indication of at least one available extension being enabled; and
saving the indication of the at least one available extension being enabled.

20. The computer-readable memory of claim 17, further comprising executing a business process by the business application using the saved customized rule.
